(19) United States
(12) Patent Application Publication
(10) Pub. No.: US 2025/0271297 A1
(43) Pub. Date: Aug. 28, 2025

(54) APPARATUS AND METHOD FOR MASS DETECTING ELECTROLUMINESCENT DEVICES ARRAY

(71) Applicant: AUO Corporation, Hsinchu City (TW)

(72) Inventors: Hung-Yi CHIANG, Hsinchu City (TW); Szu-An CHEN, Hsinchu City (TW); Jian-Jang HUANG, Hsinchu City (TW); Kuan-Heng LIN, Hsinchu City (TW); Yi-Hong CHEN, Hsinchu City (TW)

(21) Appl. No.: 18/929,672

(22) Filed: Oct. 29, 2024

(30) Foreign Application Priority Data
Feb. 22, 2024 (TW) 113106370

(51) Int. Cl. G01J 1/44; G01J 1/42

(52) U.S. Cl. CPC G01J 1/44; G01J 2001/4252; G01J 2001/444

(57) ABSTRACT

An apparatus includes a detection circuit, an image analysis module, a simulator, a calibration module and a judgment module. The detection circuit includes a translucent conductive substrate and a common pad layer electrically contacting each of the electroluminescent devices to make each of the electroluminescent devices emitting light. The image analysis module is used to capture a luminescence image of the electroluminescent devices array and obtain a measured brightness value of each of the electroluminescent devices based on the luminescence image. The simulator is used to simulate the electroluminescent devices array to obtain a theoretical brightness value of each of the electroluminescent devices. The calibration module is used to calibrate the measured brightness value and obtain a calibrated brightness value. The judgment module is used to judge a state of each of the electroluminescent devices based on a difference between the theoretical brightness value and the calibrated brightness value.

This application claims the benefit of Taiwan Application Serial No. 113106370 filed at Feb. 22, 2024 the subject matter of which is incorporated herein by reference.

### BACKGROUND

### Technical Field

The disclosure relates to an apparatus and method for testing display devices, and more particularly to an apparatus and method for mass detecting an electroluminescent devices array.

### Description of Background

With the advancement of technology, the product design trends of the display industry moving towards high quality, more comfort, large size, multi-frequency, and digitalization; and the requirements for display resolution and contrast are also getting higher and higher. Electroluminescence (EL) devices (taking micro light-emitting diode (μ-LED) display devices as an example) because of having technical advantages, such as self-luminescence, high brightness, high luminous efficiency, long life and high resolution etc., have been considered as the mainstream of next-generation display technology.

However, since the μ-LED display technology shrinks the size of LED units (die) from hundreds of microns to tens microns or even several microns, thus millions of μ-LED units in a display must be transfer from a wafer-level substrate to a packaging substrates or display panels through mass transfer. If there is no quality inspection of μ-LED units carried out to eliminate defective products before mass transfer, when it is discovered that some μ-LED units having been transferred onto the display panel is failed or have insufficient brightness, huge remediation or rework costs will be required.

The prior art technology has provided a mass detection apparatus that uses probes or needles connected to a conductive transparent film to supply power to each μ-LED unit arranged on a wafer and/or a carrier substrate, and then uses optical detection technology to check the light-emitting state of the μ-LED units after power is supplied thereon. However, as the wafer size decreases, the number of μ-LED units arranged on the wafer and/or the carrier substrate rapidly increases. Using probes to inspect the μ-LED units one by one will lead to a sharp increase in inspection time and cost. Especially when the critical dimension of the μ-LED units is less than 10 microns (μm), using the traditional probe measurement methods may cause damage to the μ-LED units due to physical impact of direct contact.

Therefore, there is a need of providing an apparatus and method for mass detecting electroluminescent devices array to obviate the drawbacks encountered from the prior art.

### SUMMARY

One aspect of the present disclosure is to provide an apparatus for mass detecting an electroluminescent devices array, wherein the apparatus includes a detection circuit, an image analysis module, a simulator, a calibration module and a judgment module. The detection circuit includes a translucent conductive substrate and a common pad layer. The translucent conductive substrate electrically contacts with a first electrode of each of the electroluminescent devices in the electroluminescent devices array. The common pad layer electrically contacts with a second electrode of each of the electroluminescent devices. The electroluminescent devices array is electrically conduct through the translucent conductive substrate and the common pad layer, so that each of the electroluminescent devices emits light. The image analysis module is used to capture a luminescence image of the electroluminescent devices array and obtain a measured brightness value of each of the electroluminescent devices based on the luminescence image. The simulator is used to simulate the electroluminescent devices array to obtain a theoretical brightness value of each of the electroluminescent devices. The calibration module is used to calibrate the measured brightness value and obtain a calibrated brightness value. The judgment module is used to judge a state of each of the electroluminescent devices based on a difference between the theoretical brightness value and the calibrated brightness value.

Another aspect of the present disclosure is to provide a method for mass detecting an electroluminescent devices array, wherein the method includes steps as follows: A detection circuit including a translucent conductive substrate and a common pad layer is firstly provided to make the translucent conductive substrate electrically contacting with a first electrode of each of a plurality of electroluminescent devices in an electroluminescent devices array, to make the common pad layer electrically contacting with a second electrode of each of the plurality of electroluminescent devices and to electrically conduct the electroluminescent devices array through the translucent conductive substrate and the common pad layer, so as to make each of the plurality of electroluminescent devices emits light. An image analysis module is provided to capture a luminescence image of the electroluminescent devices array and obtain a measured brightness value of each of the electroluminescent devices based on the luminescence image. A simulator is provided to simulate the electroluminescent devices array to obtain a theoretical brightness value of each of the electroluminescent devices. A calibration module is provided to calibrate the measured brightness value and obtain a calibrated brightness value. A judgment module is provided to judge a state of each of the electroluminescent devices based on a difference between the theoretical brightness value and the calibrated brightness value.

By providing the above-mentioned apparatus and method for mass detecting electroluminescent devices array, the electroluminescent characteristics of each electroluminescent device disposed in the electroluminescent devices array can be completely measured without being damaged, and also has advantages of lower time consumption and lower manufacturing cost.

### BRIEF DESCRIPTION OF THE DRAWINGS

The above objects and advantages of the present disclosure will become more readily apparent to those ordinarily skilled in the art after reviewing the following detailed description and accompanying drawings, in which:

FIG. 1A is a schematic structural diagram illustrating an apparatus for mass detecting a plurality of electroluminescent devices arranged in an electroluminescent devices array according to one embodiment of the present disclosure;

FIG. 1B is a cross-sectional view illustrating a partial structural of the apparatus for mass detecting along the cutting line A-A in FIG. 1A;

FIG. 1C is a flowchart illustrating a method for mass detecting the electroluminescent devices array using the apparatus for mass detecting of FIG. 1A;

FIG. 1D is a continuation of FIG. 1C;

FIG. 2A is a luminescent image of the electroluminescent devices array captured by an image analysis module according to one embodiment of the present disclosure;

FIG. 2B is a diagram illustrating the brightness distribution of the electroluminescent devices in the first row of the luminescent image in FIG. 2A;

FIG. 2C is a diagram illustrating the brightness distribution of the electroluminescent devices in the first column of the luminescent image in FIG. 2A;

FIG. 2D is a diagram illustrating a standard unit current-voltage curve according to one embodiment of the present disclosure;

FIG. 2E is a diagram illustrating a simulated equivalent circuit of the electroluminescent devices array constructed by a circuit simulation software;

FIG. 3A is a diagram illustrating the simulated brightness distribution curve of the μ-LED units in the first row of the electroluminescent devices array according to one embodiment of the present disclosure;

FIG. 3B is a diagram illustrating the simulated brightness distribution curve of the μ-LED units in the first column of the electroluminescent devices array according to one embodiment of the present disclosure;

FIG. 4A is a diagram illustrating the calibrated brightness distribution curve and the theoretical (simulated) brightness distribution curve of the μ-LED units disposed in the first row of the electroluminescent devices array according to one embodiment of the present disclosure; and

FIG. 4B is a diagram illustrating the calibrated brightness distribution curve and the theoretical (simulated) brightness distribution curve of the μ-LED units disposed in the first column of the electroluminescent devices array according to one embodiment of the present disclosure.

### DETAILED DESCRIPTION

The embodiments as disclosed below provide an apparatus and a method for mass detecting electroluminescent devices array to completely measure the electroluminescent characteristics of each electroluminescent device disposed in the electroluminescent devices array without damaging the electroluminescent device and to provide advantages of lower time consumption and lower manufacturing cost. The present disclosure will now be described more specifically with reference to the following embodiments illustrating the structure, method and arrangements thereof.

It is to be noted that the following descriptions of preferred embodiments of this disclosure are presented herein for purpose of illustration and description only. It is not intended to be exhaustive or to be limited to the precise form disclosed.

Also, it is important to point out that there may be other features, elements, steps, and parameters for implementing the embodiments of the present disclosure which are not specifically illustrated. Thus, the descriptions and the drawings are to be regard as an illustrative sense rather than a restrictive sense. Various modifications and similar arrangements may be provided by the persons skilled in the art within the spirit and scope of the present disclosure. In addition, the illustrations may not be necessarily drawn to scale, and the identical elements of the embodiments are designated with the same reference numerals.

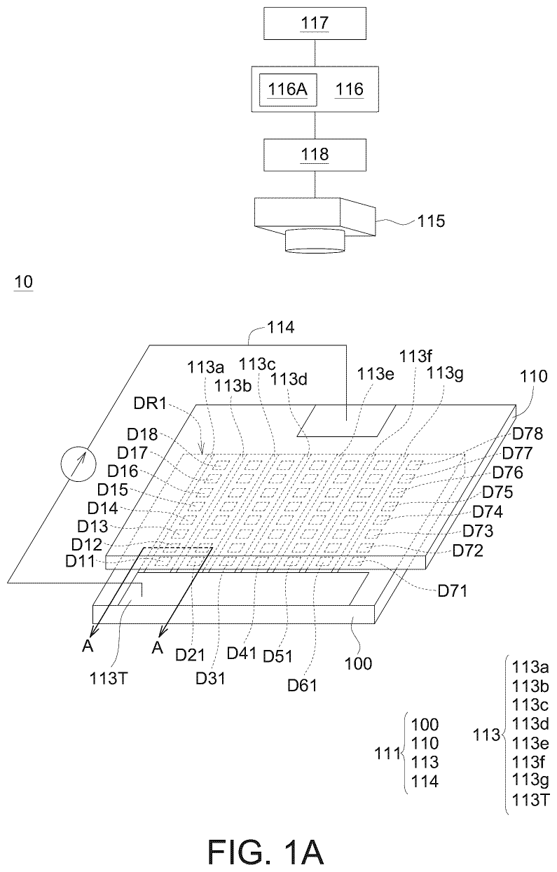

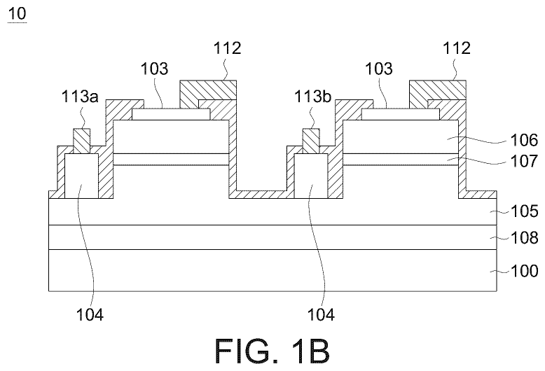

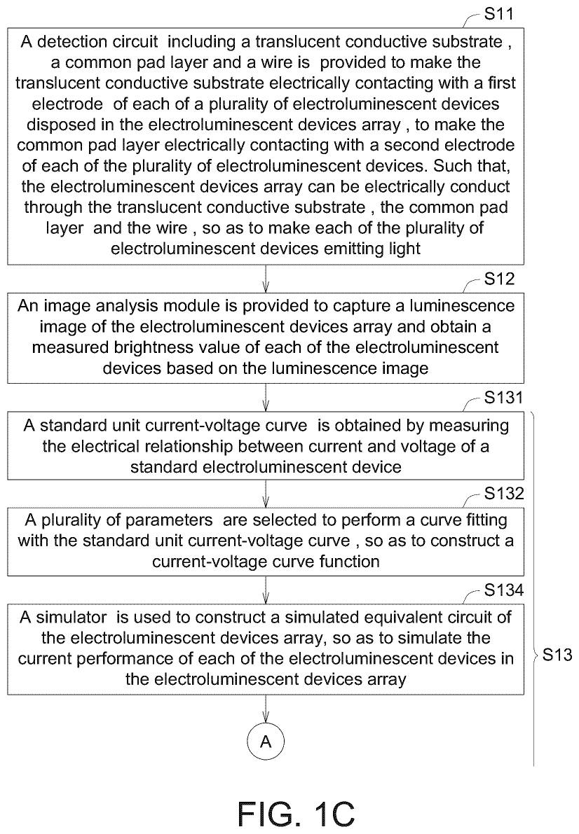

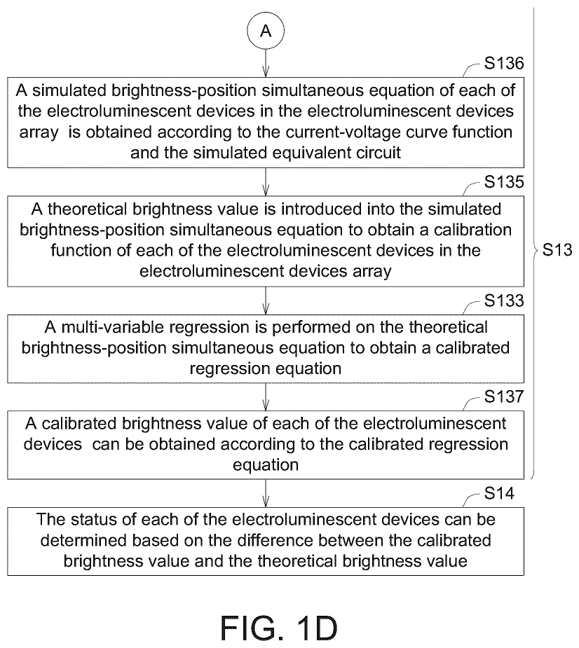

FIG. 1A is a schematic structural diagram illustrating an apparatus 10 for mass detecting a plurality of electroluminescent devices D11 to D78 arranged in an electroluminescent device array DR1 (e.g., 7 columns×8 rows) according to one embodiment of the present disclosure. FIG. 1B is a cross-sectional view illustrating a partial structural of the apparatus 10 for mass detecting along the cutting line A-A in FIG. 1A. FIG. 1C is a flowchart illustrating a method for mass detecting the electroluminescent devices array DR1 using the apparatus 10 for mass detecting of FIG. 1A.

The method for mass detecting the electroluminescent devices array DR1 includes steps as follows: Firstly, referring to step S11, a detection circuit 111 including a translucent conductive substrate 110, a common pad layer 113 and a wire 114 is firstly provided to make the translucent conductive substrate 110 electrically contacting with a patterned pad layer 112 of each of a plurality of electroluminescent devices D₁₁ to D₇₈ disposed in the electroluminescent devices array DR1, to make the common pad layer 113 electrically contacting with a second electrode 104 of each of the plurality of electroluminescent devices D₁₁ to D₇₈. Such that, the electroluminescent devices array DR1 can be electrically conduct through the translucent conductive substrate 110, the common pad layer 113 and the wire 114, so as to make each of the plurality of electroluminescent devices D₁₁ to D₇₈ emitting light.

In detail, in some embodiments of the present disclosure, the electroluminescent devices array DR1 is formed on a carrier substrate 100 and includes 56 electroluminescent devices (e.g., the plurality of electroluminescent devices D₁₁ to D₇₈) arranged to form a rectangle matrix of 7 columns×8 rows. Wherein, the carrier substrate 100 can be a wafer made of a semiconductor material (such as, silicon (Si) wafer or germanium (Ge)) or a compound semiconductor material (such as, gallium arsenide (GaAs), aluminum phosphide (AIP), gallium nitride (GaN), silicon carbide (SiC); or can be a substrate for carrying semiconductor devices. In the present embodiment, the carrier substrate 100 may be a Si wafer.

The electroluminescent devices array DR1 can be a μ-LED array, a sub-millimeter light-emitting diode (Mini LED) array or an organic light-emitting diode (OLED) array. For example, in some embodiments of the present disclosure, each of the electroluminescent devices D₁₁ to D₇₈ may be a μ-LED unit including common mode composite material including aluminum gallium arsenide (AlGaAs), gallium nitride (GaN), indium gallium nitride (InGaN), aluminum nitride (AlN), aluminum galliumnitride (AlGaN) or the arbitrary combination thereof.

In some embodiments of the present disclosure, each of the electroluminescent devices D₁₁ to D₇₈ includes a semiconductor buffer layer 108, a first conduction-type semiconductor layer 105, a second conduction-type semiconductor layer 106, an active layer 107, a first electrode 103 and a second electrode 104. Wherein the first conduction-type semiconductor layer 105, the active layer 107, the second conduction-type semiconductor layer 106 and the first electrode 103 are sequentially stacked on the semiconductor buffer layer 108. The second electrode 104 and the first electrode 103 are disposed on the same side of the second conduction-type semiconductor layer 106. The active layer 107 electrically contacts with the second conduction-type semiconductor layer 106 and the first conduction-type semiconductor layer 105; the first electrode 103 electrically contacts with the second conduction-type semiconductor layer 106; and the second electrode 104 electrically contacts with the first conduction-type semiconductor layer 105.

In the present embodiment, the semiconductor buffer layer 108 in each of the electroluminescent devices D₁₁ to D₇₈ may be an un-doped GaN layer; the first conduction-type semiconductor layer 105 may be an n-type GaN layer; the second conduction-type semiconductor layer 106 may be a p-type GaN layer; the active layer 107 may be a gallium arsenide (GaAs) multiple quantum well (MQW) layer; the first electrode 103 is a patterned metal layer including nickel/gold (Ni/Au); and the second electrode 104 is a patterned metal layer including titanium/aluminum/nickel/gold (Ti/Al/Ni/Au). Wherein, both the second electrode 104 and the first electrode 103 are disposed on the side of the second conduction-type semiconductor layer 106 away from the first conduction-type semiconductor layer 105.

The translucent conductive substrate 110 is disposed above each of the electroluminescent devices D₁₁ to D₇₈, and electrically contacts with the first electrode 103 in each of the electroluminescent devices D₁₁ to D₇₈. For example, in some embodiments of the present disclosure, the translucent conductive substrate 110 may be an indium tin oxide (ITO) substrate covering on each of the electroluminescent devices D₁₁ to D₇₈.

In the present embodiment, the translucent conductive substrate 110 electrically contacts with the first electrode 103 through a patterned pad layer 112 formed on the first electrode 103 in each of the electroluminescent devices D₁₁ to D₇₈. Wherein, the patterned pad layer 112 may be a patterned metal layer containing titanium/gold (Ti/Au). Of note, although the first electrode 103 and the second electrode 104 are disposed on the same side (lower side) of the translucent conductive substrate 110, but the translucent conductive substrate 110 does not electrically contact with the second electrode 104 in each of the electroluminescent devices D₁₁ to D₇₈.

The common pad layer 113 is stacked on the second electrode 104 in each of the electroluminescent devices D₁₁ to D₇₈ and electrically contacts with each second electrode 104 in each of the electroluminescent devices D₁₁ to D₇₈. In some embodiments of the present disclosure, the common pad layer 113 may also be a patterned metal layer including Ti/Au, formed on the second electrode 104 in each of the electroluminescent devices D₁₁ to D₇₈. In the present embodiment, the common pad layer 113 includes a plurality of finger portions 113a-113g, by which a plurality of electroluminescent devices disposed in the same column, such as the electroluminescent devices D₁₁ to D₁₈, D₂₁ to D₂₈, D₃₁ to D₃₈, D₄₁ to D₄₈, D₅₁ to D₅₈, D₆₁ to D₆₈ and D₇₁ to D₇₈, are connected in series respectively.

In the present embodiment, the common pad layer 113 further includes a connecting portion 113T disposed on the carrier substrate 100 and electrically connected to the plurality of finger portions 113a-113g. The wires 114 are also disposed on the carrying substrate 100 and electrically contacts with the translucent conductive substrate 110 and the connecting portion 113T respectively. A conductive loop can be formed between the first electrode 103 and the second electrode 104 in each of the electroluminescent devices D₁₁ to D₇₈ respectively, through the patterned pad layer 112, the common pad layer 113, the wire 114 and the translucent conductive substrate 110, so as to cause each of the electroluminescent devices D₁₁ to D₇₈ emitting light.

Next, referring to step S12, an image analysis module 115 is provided to capture a luminescence image 200 of the electroluminescent devices array DR2 and obtain a measured brightness value of each of the electroluminescent devices D₁₋₁ to D₁₃₋₂₇ based on the luminescence image 200. In some embodiments of the present disclosure, the apparatus 10 for mass detecting includes an image analysis module 115, which has an image capture device, such as a charge-coupled device (CCD), which can be used to capture the luminescence image 200 of the electroluminescent devices array DR2. By analyzing the gray-level brightness of the luminescent image 200, the actual brightness of each of the electroluminescent devices D₁₋₁ to D₁₃₋₂₇ can be obtained.

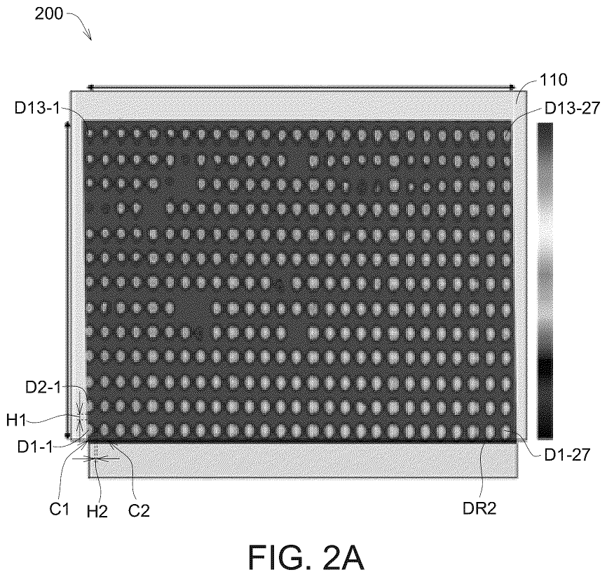

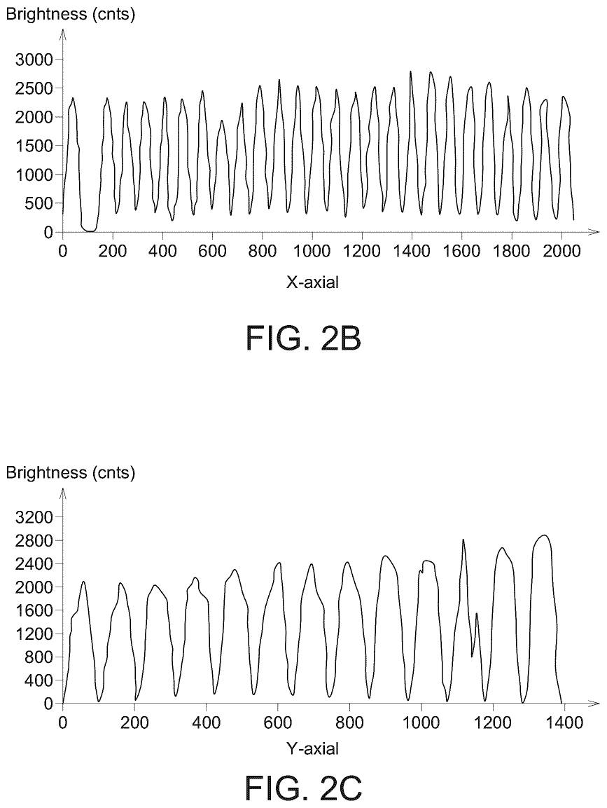

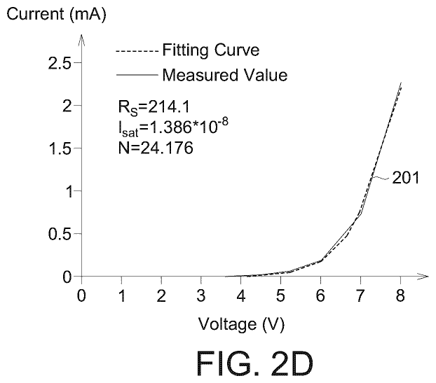

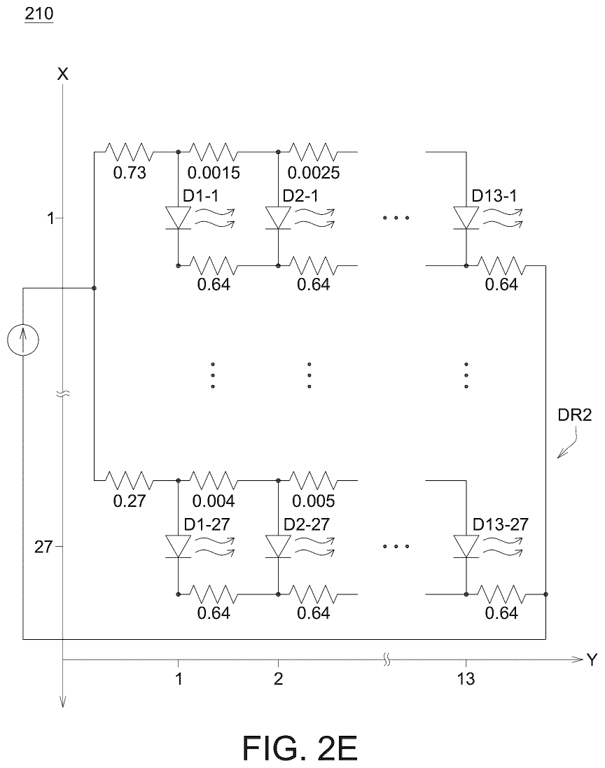

FIG. 2A is the luminescent image 200 of the electroluminescent devices array DR2 captured by the image analysis module 115 according to one embodiment of the present disclosure. FIG. 2B is a diagram illustrating the brightness distribution of the electroluminescent devices (such as, the electroluminescent devices D₁₋₁ to D₁₃₋₂₇) in the first row L1 of the luminescent image 200 in FIG. 2A. FIG. 20 is a diagram illustrating the brightness distribution of the electroluminescent devices (such as, the electroluminescent devices D₁₋₁ to D₁₃₋₁) in the first column C1 of the luminescent image 200 in FIG. 2A.

In the present embodiment, the electroluminescent devices array DR2 is a rectangular matrix of 13 rows (parallel to the X-axis)×27 columns (parallel to the Y-axis) composed of 351 μ-LED units D₁₋₁ to D₁₃₋₂₇. The size of each μ-LED units D₁₋₁ to D₁₃₋₂₇ is 13×20 square micrometers (μm²). The pitch H1 between two adjacent μ-LED units (e.g., the μ-LED units D₁₋₁ and D₁₃₋₁) respectively disposed on two adjacent rows (such as, the first row L1 and the second row L2) is 52 micrometers (μm). The pitch H2 between two adjacent μ-LED units (e.g., the μ-LED units D₁₋₁ and D₁₋₂) respectively disposed on two adjacent columns (such as, the first column C1 and the second column C2) is 38 μm.

As shown in FIGS. 2B and 2C, each of the μ-LED units D₁₋₁ to D₁₃₋₂₇ are connected to each other in parallel, when the total injected current is 45.63 milliamperes (mA), the theoretical volumetric flow rate per unit area flowing through each μ-LED units D₁₋₁ to D₁₃₋₂₇ is about 50 ampere/square centimeters (A/cm²). However, since the amount of current flowing through each of the μ-LED units D₁₋₁ to D₁₃₋₂₇ may vary depending on the distance between its position and the power source, thus the actual measured values in brightness (luminance) of the μ-LED units D₁₋₁ to D₁₃₋₂₇ may be also different.

Referring to step S13: a calibration module 116 is provided to calibrate the measured brightness value of the electroluminescent devices (such as, the μ-LED units D₁₋₁ to D₁₃₋₂₇) and obtain a brightness calibrated parameter of each of the e μ-LED units D₁₋₁ to D₁₃₋₂₇. For example, in some embodiments of the present disclosure, the calibration module 116 includes a simulator 116A used to perform computer simulation on the current performance of each μ-LED units D₁₋₁ to D₁₃₋₂₇, so as to obtain a brightness-position equation for each of the μ-LED units D₁₋₁ to D₁₃₋₂₇. Then use a theoretical brightness value (for example, 3600a.u.) to calibrate the brightness-position equation to obtain the brightness calibration parameters of each of the μ-LED units D₁₋₁ to D₁₃₋₂₇.

In the present embodiment, step S13 may include several sub-steps as follows: Firstly, referring to sub-step S131: A standard unit current-voltage curve (I-V Curve) 201 is obtained by measuring the electrical relationship between current and voltage of a standard electroluminescent device (such as, the μ-LED unit D₁₋₁). For example, in the present embodiment, at least one μ-LED unit (e.g., the μ-LED unit D₁₋₁) in the electroluminescent devices array DR2 can be selected as a standard unit, and the electrical relationship between its current and voltage can be measured to obtain a curve serving as the standard unit current-voltage curve 201 (as shown in FIG. 2D).

Then referring to sub-step S132: A plurality of parameters, such as the series resistance Rₛ of the μ-LED unit D₁₋₁, the saturation current Iₛₐₜ flowing through the μ-LED unit D₁₋₁, and the ideality factor n, are selected to perform a curve fitting with the standard unit current-voltage curve 201, so as to construct a current-voltage curve function, expressed by Equation 1:

$$I = {I}_{sat} exp ( \frac{e ( v - {IR}_{s} )}{nkT} ) \qquad ( Equation 1 )$$

Where υ is the voltage, T is the temperature, and κ is the Boltzmann constant.

Subsequently, referring to sub-step S133, a simulator 118 is used to construct a simulated equivalent circuit 210 of the electroluminescent devices array DR2 (as shown in FIG. 2E), so as to simulate the current performance of each of the electroluminescent devices (such as, the μ-LED units D₁₋₁ to D₁₃₋₂₇) in the electroluminescent devices array DR2. For example, in the present embodiment, a simulator 118 including a circuit simulation software (eg, LTspice) can be used to construct the simulated equivalent circuit diagram 210 of the electroluminescent devices array DR2, and calculate the series resistance value Rₛ of each of the μ-LED units D₁₋₁ to D₁₃₋₂₇ and the saturation current Iₛₐₜ flowing through each of the μ-LED units D₁₋₁ to D₁₃₋₂₇.

Next, referring to sub-step S134: A simulated brightness-position simultaneous equation of each of the electroluminescent devices (e.g., the μ-LED units D₁₋₁ to D₁₃₋₂₇) in the electroluminescent devices array DR2 is obtained according to the current-voltage curve function and the simulated equivalent circuit 210. For example, in the present embodiment, the position (e.g., position coordinates (x, y)) of each of the μ-LED units D₁₋₁ to D₁₃₋₂₇ in the electroluminescent devices array DR2 and its corresponding current performance parameters (such as, the series resistance value Rₛ, the saturation current Iₛₐₜ and the ideality factor n) can be brought into the current-voltage curve function, and a curve fitting is performed to obtain the simulated brightness-position simultaneous equation, expressed by Equation 2:

$$g ( y ) = 5.355 \times \cdot {e}^{( \frac{y}{6.5662} )} + 3581 \qquad ( Equation 2 )$$

$$h ( x ) = 2870.136 + 5.625 \times \cdot {e}^{- 0.5 {( ( x - 19.83481 ) / 8.94924 )}^{2}}$$

Wherein x and y are the position coordinates of each of the μ-LED units D₁₋₁ to D₁₃₋₂₇ in the electroluminescent devices array DR2.

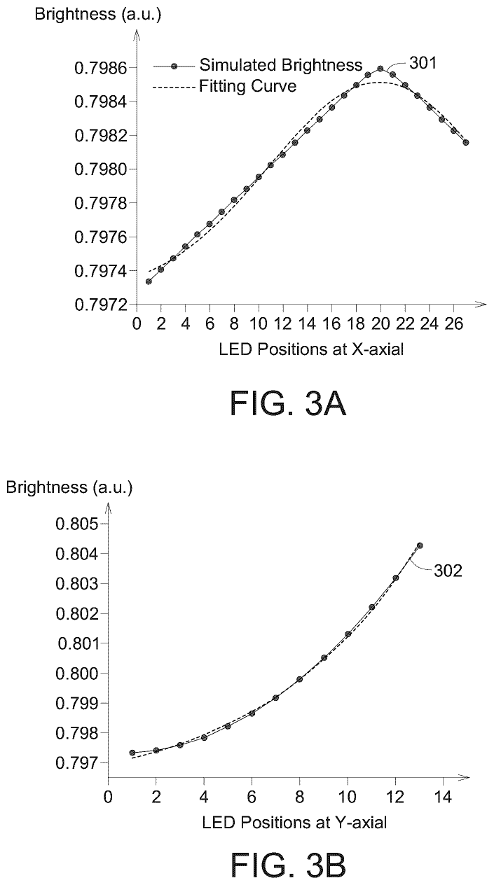

By bringing the position coordinates (x, y) of each of the μ-LED units D₁₋₁ to D₁₃₋₂₇ in the electroluminescent devices array DR2 into the simulated brightness-position simultaneous equation, the simulated brightness distribution curve 301 (as shown in FIG. 3A) of the μ-LED units disposed in each row (e.g., the μ-LED units D₁₋₁ to D₁₋₂₇ disposed in the first row L1) of the electroluminescent devices array DR2 and the simulated brightness distribution curve 302 (as shown in FIG. 3B) of the μ-LED units disposed in each column (e.g., the μ-LED units D₁₋₁ to D₁₃₋₁ disposed in the first column C1) of the electroluminescent devices array DR2, can be obtained.

Referring to sub-step S135: A theoretical brightness value is introduced into the simulated brightness-position simultaneous equation (Equation 2) to obtain a calibration function of each of the electroluminescent devices (e.g., the μ-LED units D₁₋₁ to D₁₃₋₂₇) in the electroluminescent devices array DR2. In the present embodiment, assuming that the theoretical brightness value of a standard μ-LED unit is 3600 a.u., by bring the theoretical brightness value into the simulated brightness-position simultaneous equation (Equation 2), the calibration function of each of the μ-LED units D₁₋₁ to D₁₃₋₂₇ in the electroluminescent devices array DR2 can be obtained, express by Equation 3:

$$N ( y ) = \cdot \frac{3600}{g ( y )} = \cdot \frac{672.269}{{e}^{0.152295 y} + 668.723} . \qquad ( Equation 3 )$$

$$K ( x ) = \cdot \frac{3600}{h ( x )} = \cdot \frac{1}{0.0015625 \times {e}^{- 0.00624306 {( x - 19.8348 )}^{2}} + 0.79726}$$

The calibration factor of each of the μ-LED units D₁₋₁ to D₁₃₋₂₇ can be calculated, according to the calibration function (Equation 3). For example, in the present embodiment, the calibration factor value of each of the μ-LED units D₁₋₁ to D₁₃₋₂₇ can be calculated by bring x and y of the position coordinate of each of the μ-LED units D₁₋₁ to D₁₃₋₂₇ into the calibration function (Equation 3).

Referring to sub-step S136: A multi-variable regression is performed on the calibration function (Equation 3) to obtain a calibrated regression equation, express by Equation 4:

$$C ( x , y ) = 26.701 \times N ( y ) + 69.54 \times K ( x ) - 112.7 \qquad ( Equation 4 )$$

Referring to sub-step S137: A calibrated brightness value of each of the electroluminescent devices (e.g., the μ-LED units D₁₋₁ to D₁₃₋₂₇) can be obtained according to the calibrated regression equation (Equation 4). For example, in the present embodiment, the position coordinates (x, y) of each of the μ-LED units D₁₋₁ to D₁₃₋₂₇ in the electroluminescent devices array DR2 are brought into the calibrated regression equation (Equation 4), and the brightness calibrated parameter C(x,y) of each of the μ-LED units D₁₋₁ to D₁₃₋₂₇ can be obtained.

Referring to step S14: The status of each of the electroluminescent devices (e.g., μ-LED units D₁₋₁ to D₁₃₋₂₇) can be determined based on the difference between the calibrated brightness value and the theoretical brightness value. For example, in the present embodiment, a judgment module 117 can be used to determine the status of each of the μ-LED units D₁₋₁ to D₁₃₋₂₇ based on the brightness calibrated parameter C(x,y) of each of the μ-LED units D₁₋₁ to D₁₃₋₂₇. In some embodiments of the present disclosure, the apparatus 10 for mass detecting includes a judgment module 117 that can multiply the measured brightness value of each of the μ-LED units D₁₋₁ to D₁₃₋₂₇ by the brightness calibrated parameter C(x,y) to obtain the calibrated brightness value of each of the μ-LED units D₁₋₁ to D₁₃₋₂₇.

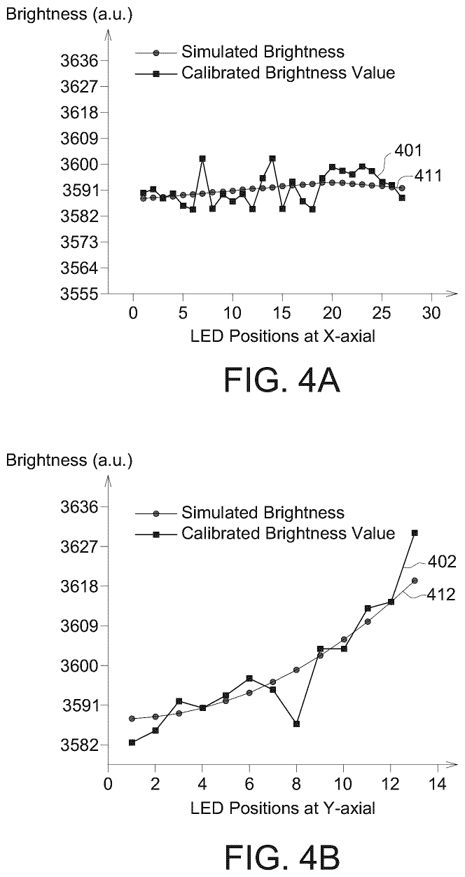

FIG. 4A is a diagram illustrating the calibrated brightness distribution curve 401 and the theoretical (simulated) brightness distribution curve 411 of the μ-LED units D₁₋₁ to D₁₋₂₇ disposed in the first row L1 of the electroluminescent devices array DR2 according to one embodiment of the present disclosure; and FIG. 4B is a diagram illustrating the calibrated brightness distribution curve 402 and the theoretical (simulated) brightness distribution curve 412 of the μ-LED units D₁₋₁ to D₁₃₋₁ disposed in the first column C1 of the electroluminescent devices array according to one embodiment of the present disclosure. By subtracting the calibrated brightness distribution curve 401 from the theoretical (simulated) brightness distribution curve 411, the difference between the calibrated brightness value and the theoretical brightness value of each of the μ-LED units D₁₋₁ to D₁₋₂₇ can be obtained. By subtracting the calibrated brightness distribution curve 402 and the theoretical (simulated) brightness distribution curve 412, the difference between the calibrated brightness value and the theoretical brightness value of each of the μ-LED units D₁₋₁ to D₁₃₋₁ can be obtained.

After that, by calculating the difference between the calibrated brightness value and the theoretical brightness value of each of the μ-LED units D₁₋₁ to D₁₃₋₂₇, the light-emitting state of each of the μ-LED units D₁₋₁ to D₁₃₋₂₇ can be determined.

In the present embodiment, when a ratio of the difference between the calibrated brightness value and the theoretical brightness value and the theoretical brightness value of a certain μ-LED unit (such as, the μ-LED unit D₁₋₁ to the theoretical brightness value is greater than a threshold (for example, 1%), it can be determined that the μ-LED unit D₁₋₁ is failed. In some embodiments pf the present disclosure, when the mean error (ME) of the brightness of the μ-LED units D₁₋₁ to D₁₃₋₂₇ in the electroluminescent devices array DR2 is greater than the threshold (for example, 1%), it can be determined that the electroluminescent devices array DR2 is failed. Then enter the next process stage, such as rework, replacement of the μ-LED units, or abandonment the product in process . . . etc.

According to the above embodiment, an apparatus and a method for mass detecting are disclosed, in which a detection circuit including a translucent conductive substrate and a common pad layer is used. The electroluminescent devices array is firstly covered by the translucent conductive substrate firstly, and the electroluminescent devices array is then conducted through the translucent conductive substrate and the common pad layer to cause each of the electroluminescent devices disposed in the electroluminescent devices array emitting light. An image analysis module is used to capture a luminescence image of the electroluminescent devices array to obtain a measured brightness value of each of the electroluminescent devices.

Then, a current-voltage curve function of a standard electroluminescent device is obtained by measuring the standard electroluminescent device. Next, a circuit simulation software is used to construct a simulated equivalent circuit of the electroluminescent devices array to simulate the current performance of each of the electroluminescent devices. The simulated result is brought into the current-voltage curve function to perform a curve fitting to obtain a simulated brightness-position simultaneous equation. Then a theoretical brightness value is brought into the simulated brightness-position equation to obtain a theoretical brightness value of each of the electroluminescent device. A calibrated regression equation can be obtained after performing a multivariable regression on the theoretical brightness values. The brightness calibrated parameter C(x,y) can be obtained by bringing the position coordinates of each electroluminescent device into the calibrated regression equation. Multiply the actual measured brightness value of each electroluminescent element by the brightness correction parameter and then compare it with the corresponding theoretical brightness value. By comparing the values, the status of each electroluminescent element can be judged. The status of each of the electroluminescent devices can be determined by multiplying the actual measured brightness value of each of the electroluminescent devices by the brightness calibrated parameter C(x,y), and then comparing it with the corresponding theoretical brightness value.

By providing the above-mentioned apparatus and method for mass detecting electroluminescent devices array, the electroluminescent characteristics of each electroluminescent device disposed in the electroluminescent devices array can be completely measured without being damaged, and also has advantages of lower time consumption and lower manufacturing cost.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An apparatus for mass detecting an electroluminescent devices array, comprising:
a detection circuit, comprising:
a translucent conductive substrate, electrically contacting with a first electrode of each of a plurality of electroluminescent devices disposed in the electroluminescent devices array; and
a common pad layer, electrically contacts with a second electrode of each of the plurality of electroluminescent devices; wherein the electroluminescent devices array is electrically conduct through the translucent conductive substrate and the common pad layer to make each of the plurality of electroluminescent devices emitting light;
an image analysis module, used to capture a luminescence image of the electroluminescent devices array and obtain a measured brightness value of each of the plurality of electroluminescent devices based on the luminescence image;
a simulator, used to simulate the electroluminescent devices array to obtain a theoretical brightness value of each of the plurality of electroluminescent devices
a calibration module, used to calibrate the measured brightness value and obtain a calibrated brightness value; and
a judgment module, used to judge a state of each of the plurality of electroluminescent devices based on a difference between the theoretical brightness value and the calibrated brightness value.

2. The apparatus according to claim 1, wherein the electroluminescent devices array is a micro light-emitting diode (μ-LED) array, a sub-millimeter light-emitting diode (Mini LED) array or an organic light-emitting diode (OLED) array.

3. The apparatus according to claim 1, wherein the translucent conductive substrate is an indium tin oxide (ITO) substrate.

4. The apparatus according to claim 1, wherein the second electrode and the first electrode are disposed on the same side of the translucent conductive substrate.

5. The apparatus according to claim 1, wherein the translucent conductive substrate electrically contacts with the first electrode and the second electrode by a patterned conductive layer formed on the electroluminescent devices array, so as to form a conductive loop.

6. The apparatus according to claim 5, wherein the patterned metal layer comprises titanium/gold (Ti/Au).

7. The apparatus according to claim 1, wherein the image analysis module comprises a charge-coupled device (CCD).

8. The apparatus according to claim 1, wherein obtaining of the theoretical brightness value comprises following steps:
obtaining a curve function of a standard unit current-voltage curve (I-V Curve) by measuring electrical relationship between current and voltage of a standard electroluminescent device;
constructing a simulated equivalent circuit diagram of the electroluminescent devices array;
obtaining a simulated brightness-position simultaneous equation expressed by:
$$g ( y ) = 5.355 \times \cdot {e}^{( \frac{y}{6.5662} )} + 3581$$
$$h ( x ) = 2870.136 + 5.625 \times \cdot {e}^{- 0.5 {( ( x - 19.83481 ) / 8.94924 )}^{2}}$$
of the electroluminescent devices array based on the curve function and the simulated equivalent circuit diagram, wherein x and y are position coordinate of each of the plurality of electroluminescent devices disposed in the electroluminescent devices array;
by bring a theoretical brightness value of 3600 a.u., by bring into the simulated brightness-position simultaneous equation,
obtaining a calibration function expressed by:
$$N ( y ) = \cdot \frac{3600}{g ( y )} = \cdot \frac{672.269}{{e}^{0.152295 y} + 668.723}$$
$$K ( x ) = \cdot \frac{3600}{h ( x )} = \cdot \frac{1}{0.0015625 \times {e}^{- 0.00624306 {( x - 19.8348 )}^{2}} + 0.79726}$$
bring x and y of the position coordinate of each of the plurality of electroluminescent devices into the calibration function.

9. The apparatus according to claim 8, wherein obtaining of the calibrated brightness value comprises following steps:
performing a multi-variable regression on the calibration function to obtain a calibrated regression equation, express by:
$$C ( x , y ) = 26.701 \times N ( y ) + 69.54 \times K ( x ) - 112.7$$
obtaining a brightness calibrated parameter C(x,y) according to the calibrated regression equation; and
multiplying the measured brightness value by the brightness calibrated parameter C(x,y).

10. The apparatus according to claim 8, wherein the curve function is expressed by:
$$I = {I}_{sat} exp ( \frac{e ( v - {IR}_{s} )}{nkT} )$$
where υ is the voltage, T is the temperature, and κ is the Boltzmann constant.

11. A method for mass detecting an electroluminescent devices array, comprising:
providing detection circuit comprising:
a translucent conductive substrate, electrically contacting with a first electrode of each of a plurality of electroluminescent devices disposed in the electroluminescent devices array; and
a common pad layer, electrically contacts with a second electrode of each of the plurality of electroluminescent devices; wherein the electroluminescent devices array is electrically conduct through the translucent conductive substrate and the common pad layer to make each of the plurality of electroluminescent devices emitting light;
providing an image analysis module to capture a luminescence image of the electroluminescent devices array and obtain a measured brightness value of each of the plurality of electroluminescent devices based on the luminescence image;
providing a simulator to simulate the electroluminescent devices array to obtain a theoretical brightness value of each of the plurality of electroluminescent devices;
providing a calibration module to calibrate the measured brightness value and obtain a calibrated brightness value; and
providing a judgment module to judge a state of each of the plurality of electroluminescent devices based on a difference between the theoretical brightness value and the calibrated brightness value.

12. The method according to claim 11, wherein the electroluminescent devices array is a μ-LED array, a Mini LED array or an OLED array.

13. The method according to claim 11, wherein the translucent conductive substrate is an ITO substrate.

14. The method according to claim 11, wherein the second electrode and the first electrode are disposed on the same side of the translucent conductive substrate.

15. The method according to claim 11, wherein the translucent conductive substrate electrically contacts with the first electrode and the second electrode by a patterned conductive layer formed on the electroluminescent devices array, so as to form a conductive loop.

16. The method according to claim 15, wherein the patterned metal layer comprises Ti/Au.

17. The method according to claim 11, wherein the image analysis module comprises a CCD.

18. The method according to claim 11, wherein obtaining of the theoretical brightness value comprises following steps:
obtaining a curve function of a standard unit I-V Curve by measuring electrical relationship between current and voltage of a standard electroluminescent device;
constructing a simulated equivalent circuit diagram of the electroluminescent devices array;
obtaining a simulated brightness-position simultaneous equation expressed by:
$$g ( y ) = 5.355 \times \cdot {e}^{( \frac{y}{6.5662} )} + 3581$$
$$h ( x ) = 2870.136 + 5.625 \times \cdot {e}^{- 0.5 {( ( x - 19.83481 ) / 8.94924 )}^{2}}$$
of the electroluminescent devices array based on the curve function and the simulated equivalent circuit diagram, wherein x and y are position coordinate of each of the plurality of electroluminescent devices disposed in the electroluminescent devices array;
obtaining a calibration function expressed by:
$$N ( y ) = \cdot \frac{3600}{g ( y )} = \cdot \frac{672.269}{{e}^{0.152295 y} + 668.723}$$
$$K ( x ) = \cdot \frac{3600}{h ( x )} = \cdot \frac{1}{0.0015625 \times {e}^{- 0.00624306 {( x - 19.8348 )}^{2}} + 0.79726}$$
by bring a theoretical brightness value of 3600 a.u., by bring into the calibration function,
bring x and y of the position coordinate of each of the plurality of electroluminescent devices into the calibration function.

19. The method according to claim 18, wherein obtaining of the calibrated brightness value comprises following steps:
performing a multi-variable regression on the calibration function to obtain a calibrated regression equation, express by:
$$C ( x , y ) = 26.701 \times N ( y ) + 69.54 \times K ( x ) - 112.7$$
obtaining a brightness calibrated parameter C(x,y) according to the calibrated regression equation; and
multiplying the measured brightness value by the brightness calibrated parameter C(x,y).

20. The method according to claim 18, wherein the curve function is expressed by:
$$I = {I}_{sat} exp ( \frac{e ( v - {IR}_{s} )}{nkT} )$$
where υ is the voltage, T is the temperature, and κ is the Boltzmann constant.
